(19) United States
(12) Patent Application Publication
(10) Pub. No.: US 2017/0086142 A1
(43) Pub. Date: Mar. 23, 2017

(54) METHOD TO SAVE POWER USAGE IN MOBILE DEVICES

(71) Applicant: International Business Machines Corporation, Armonk, NY (US)

(72) Inventors: Judith H. Bank, Cary, NC (US); Lisa M. Bradley, Cary, NC (US); Aaron J. Quirk, Cary, NC (US); Lin Sun, Morrisville, NC (US)

(21) Appl. No.: 14/862,952

(22) Filed: Sep. 23, 2015

(51) Int. Cl. H04W 52/02; H04W 4/02; G01C 21/34; H04L 29/08

(52) U.S. Cl. CPC H04W 52/0264; H04L 67/22; H04W 4/028; H04W 52/0225; G01C 21/34; H04W 88/02

(57) ABSTRACT

A mobile device that includes a cellular network connection device capable of connecting to a cellular network. The device also includes an application that communicates through the cellular network connection device to a remote device, a context memory that records information about a user's use of the mobile device and a battery management module that limits a frequency that the application communicates to the remote device based on a current location of the mobile device and information in the context memory.

### BACKGROUND

The present application relates generally to a data processing apparatus and method and more specifically to systems and methods to increase battery length for mobile devices.

The term “mobile device” refers to any device that may connect to a remote server over a communication network. A communication network may be a cellular or data (e.g., wi-fi) network. As mobile devices continue to become a part of everyday life, an aspect of mobile devices is energy management. The performance of mobile devices has greatly improved over the years. Mobile devices are now capable of storing applications that perform complex computational tasks such as, for example, map and direction generation, image recognition, and image/sound processing. However, as the complexity of the computations and tasks increase, the amount of energy required to carry out the computations and tasks also increases. For example, a geographical mapping application may include a feature of rendering a 3D map of a two-dimensional geographic location. The task of rendering the 3D map can require a large number of computations and the duration of the computations may be extensive. Consequently, many common tasks desired by users of today's mobile devices can rapidly consume the mobile device's available energy, i.e., drain the battery energy, in order to perform the necessary computations.

While there have been gradual improvements in battery technology, advancements to this date have not kept up with energy requirements of modem computational tasks. Further, the trend toward smaller, slimmer devices leads to little increase in capacity despite improvements in energy density.

Any attempt to reduce battery usage, however, may include drawbacks. For instance, it has been proposed to save battery by dimming mobile device screens during times when the mobile device is not being used or when the battery becomes low. Such measures, however, a reactive, not proactive and save battery life when it is low, not before it becomes low. Further, such solutions are applied to the device as a whole and may hinder the operation of particular applications that the user is interested in operating.

### SUMMARY

According to an embodiment of the present invention, a mobile device that includes a cellular network connection device capable of connecting to a cellular network is disclosed. The device also includes an application that communicates through the cellular network connection device to a remote device, a context memory that records information about a user's use of the mobile device and a battery management module that limits a frequency that the application communicates to the remote device based on a current location of the mobile device and information in the context memory.

In another embodiment a mobile device that includes a cellular network connection device capable of connecting to a cellular network is disclosed. The device of this embodiment includes an application that operates on the mobile device and communicates with one or more other mobile devices, a context memory that records information about a user's use of the mobile device and a battery management module that limits at least one battery consuming aspect of the application based on a current location of the mobile device or of the one or more other mobile devices.

In yet another embodiment, a method of controlling battery usage in a mobile device is disclosed. The method includes: determining a frequency an application operating on the mobile communicates through a cellular network connection device to a remote device; recording information in a context memory on the mobile phone that records information about a user's use of the mobile device; and limiting a frequency with a battery management module on the mobile device that the application communicates to the remote device based on a current location of the mobile device and information in the context memory.

### BRIEF DESCRIPTION OF THE DRAWINGS

FIG. 1 shows a power system configured to manage battery energy of a mobile device according to one embodiment;

FIG. 2 shows a flow chart of a method of operating a mobile device according to one embodiment; and

FIG. 3 shows a block diagram of example components of a mobile device.

### DETAILED DESCRIPTION

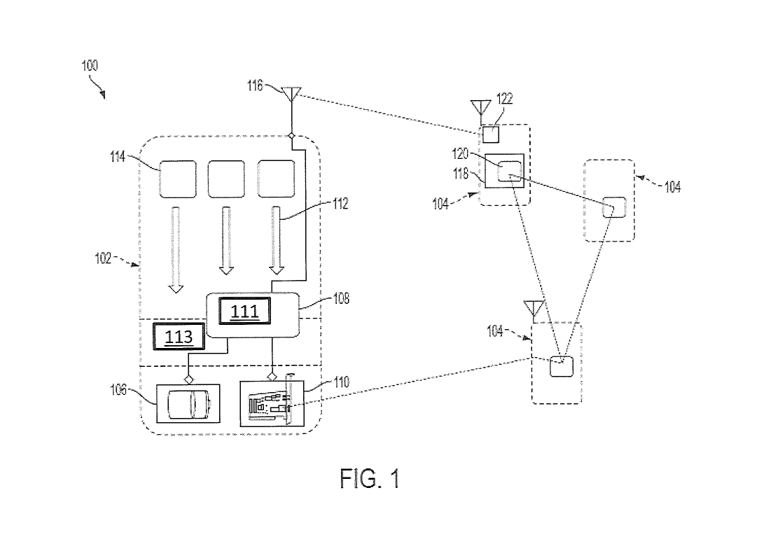

Referring now to FIG. 1, a power system 100 configured to manage battery energy of a mobile device is illustrated according to an exemplary embodiment. By conserving the battery energy, the operation of the mobile device may be extended over an increased time period. The power system 100 includes a primary mobile device 102 and a plurality of peer devices 104. The primary mobile device 102 may include, but is not limited to, a cellular telephone, a laptop computer, a tablet computer, and a mobile media device. The peer devices 104 may include, but are not limited to, a cellular telephone, a personal computer, a laptop computer, a tablet computer, a mobile media device, an internet server, a cloud server microcontroller to control operation of a cloud server, and an automotive microcontroller. The connection between a primary mobile device 102 and a particular peer device 104 may be point-to-point or may be through an intermediate location. For example, the primary mobile device 102 may communicate to a cell tower and then to a peer device 104.

The primary mobile device 102 (which may also be referred to simply as a “mobile device” herein) includes a power unit 106, an operating system (OS) 108, and a main communication module 110. The power unit 106 is configured to power the primary mobile device 102. The power unit 106 includes, for example, a rechargeable battery. When the power unit 106 is mains-connected, i.e., connected to a main power source such as a wall-mounted power outlet, the power unit 106 provides a constant and full power to the primary mobile device 102. When the power unit 106 is disconnected from the main power, however, the primary mobile device 102 is powered by a battery included in the power unit 106. As time proceeds, the energy level of the battery decreases until an insufficient amount of energy is available to operate the primary mobile device 102. The primary mobile device 102 must then shut-down. The reduction of battery energy, i.e., battery drainage, is affected by the operation of the primary mobile device 102. For example, the battery may drain faster when the primary mobile device 102 performs a high number of computations, where the computations are carried out over a long duration of time or where the mobile device 102 must repeatedly make contact with one of the peer devices 104 such as when getting map directions from a server. Accordingly, controlling the computations executed by the primary mobile device 102 or the number of contacts with another device may conserve battery energy and extend the operating time of the primary mobile device 102.

The OS 108 includes a collection of software and hardware components that operate the primary mobile device 102 and perform various computations for locally executing tasks 112 associated with applications 114 stored on memory of the primary mobile device 102 as understood by one of ordinary skill in the art. The tasks 112 may include raw data, i.e., non-computed data, which generates a desired object in response to computing the raw data and completing the task. For example, the task 112 may include sending non-computed 2D map data, i.e., raw 2D data, to the OS 108 to undergo one or more computations. The OS 108 receives the raw 2D data and performs the computations on the 2D data to generate corresponding 3D data. Based on the 3D data, the OS 108 generates a 3D rendering of the 2D map data, and displays the 3D rendering to a user. Of course, other types of rendering may be used and 3D rendering is not required.

One of the applications 114 may be a GPS application that determines a location of the mobile device 102. Of course, the GPS application may only interpret location data that is determined by another application (e.g., application 120) based on the mobile devices' 100 location relative to know points (e.g., cell towers and the like).

The OS 108 may also electrically communicate, i.e., transmit and/or receive data, with the power unit 106 and the main communication module 110. More specifically, the OS 108 may determine an energy level of the battery, and the remaining amount of energy and/or time left to power the primary mobile device 102 in response to communicating with the power unit 106. The OS 108 may further utilize the main communication module 110 to electrically receive and/or transmit data such as, for example, one or more tasks 112 associated with a respective applications 114 stored on the primary mobile device 102. The main communication module 110 may include a wireless network module, such as Bluetooth module. The main communication module 110 may also be in electrical communication with a cellular antenna 116. The primary mobile device 102, therefore, may transmit and/or receive data according to a variety of wireless protocols including, but not limited to, Bluetooth, radio frequency (RF), Wi-Fi and cellular wireless standard protocols such as 3G, 4G, Long Term Evolution (LTE), etc.

The peer devices 104 may each include a peer OS 118 that operates the peer device 104 and performs various computations for executing tasks associated with applications stored on the peer device 104. The OS 108 may include one or more applications 111 that control are used herein to control battery usage. The application 111 can be another of the application 114 or could be part of the OS 108. In one embodiment, the application 111 may control a frequency of communications with a peer device 104. The peer device 104 may include an API 120 in some instances.

One way to save power and, thus, battery life, is to limit or otherwise reduce the frequency interval of the mobile devices 100 communication communication with APIs 120 (e.g., server API's) when certain conditions are met. In one embodiment, the determination of when to save battery (by any method disclosed herein) is made by application 111. In one embodiment, information about the user's prior experiences may be used to limit the frequency of commutation. The prior experiences may be stored, for example, in a “prior experiences” memory 113. This memory 113 may also be referred to as a “context memory” herein.

The following examples and the above description have referenced mapping programs. It shall be understood that the teachings herein are not so limited and could be applied to any situation where an application frequently interacts with an external server or peer device 104. In some embodiments, provided is an intelligent method (operated by application 111) to reduce the frequency interval of application communication with server APIs when certain conditions are met to save power usage in mobile device. The conditions may be saved in the context memory 113. In another embodiment, the conditions may also help determine when it is acceptable to dim a user's screen to further limit battery usage. In yet another embodiment, based on context, certain applications may be exited or otherwise cause to reduce power consumption when conditions warrant. For example, when using a mapping/driving destination application, the mobile device may close the program when the user reaches the destination or remains at the destination for a longer than a particular amount of time.

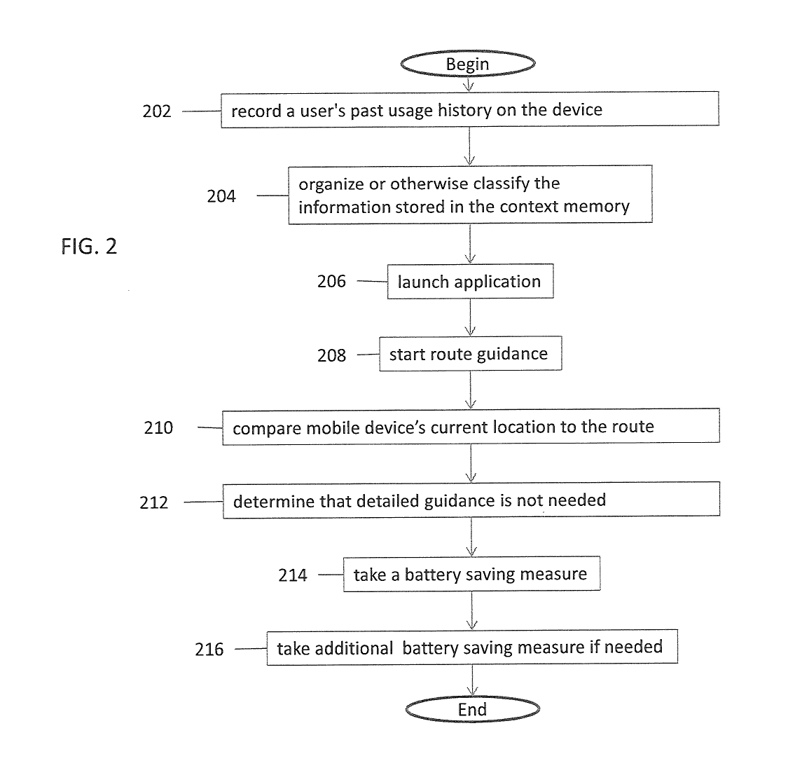

FIG. 2 shows an example flow chart that may operate according to one embodiment. The processes can be conducted by a combination of a particular application 114 resident on mobile device 102, the context memory 113 and the application 111. In this manner, the application 111 could be considered a context based battery manager that limits communication or other energy expenditure based on context and/or location. Of course, other limits could be applied as well. For example, the application 111 could also limit any outputs such as screen brightness, instruction volume or even exit an application.

In the above embodiments, the application 111 has been described as being based on location of the mobile device 102. That definition is not limited to only physical location. For instance, it some cases, based on the context of nearby other devices 104. For example, crowd sourcing from other devices 104 may indicate that the devices are in a movie theatre, church or hospital, and turn off all games, videos, etc.

At block 202 a user's past usage history on the device may be recorded. For example, a history or routes take may be stored in the context memory 113 as the user traverses a map application guide route. This could be thought of a tracking the route in some instances.

At block 204 the application 111 may organize or otherwise classify the information stored in the context memory 113. For example, such classification may include determing common roads that user drives a lot based on user's driving experiences. Based, for example, on a frequency of travel, the application may determine roads/intersections are well known to the user where the user doesn't need any help during normal traffic. Examples of classification may include: favorite routes such as from work to home, from work to day care, from home to favorite park, grocery story, and church. Along the routes, which portion of which roads and intersections are well known to the user.

At block 206 an application 114 such as a guidance program is launched. In the case that the application 114 is a guidance program, at block 208 the route that is going to be traversed is determined by the application 120 and transmitted to the mobile device 102. At block 210, the current location of the mobile device 102 is compared to the route. For example, user needs to travel from point A to point B. The application 111 may know user is already familiar with point B as it is a location that appears often in the context memory 113 (see block 204). However, point A may not occur often or at all in the context memory. In such a case, when the application 114 is operated when the user gets close to point B, the application 111 can determine that detailed guidance is not needed at block 212. The application 111 can then, at block 214 take a battery saving measure. For example, a battery saving measure could include: checking if there is any traffic ahead in the reminder of routes to point B. If not, exit out of application 114; checking if there is any traffic ahead in the reminder of routes to point B and if not reducing the refresh interval/dim the screen of the application with the server; and checking if there is any traffic ahead in the reminder of routes to point B and if likely, reducing the refresh interval/dim the screen of the application with the server, but increasing the refresh interval when detecting user in traffic jam. Of course, any of the above could be performed without taking into account traffic.

In one instance, after the rate is reduced (or another action such as dimming the screen has been taken or voices cancelled), the application 114 could be exited if the destination is reached or if the user stops the car even if not at the destination (e.g., the user pulls over to go into a store). Such is referred to as an additional battery saving measure in block 216.

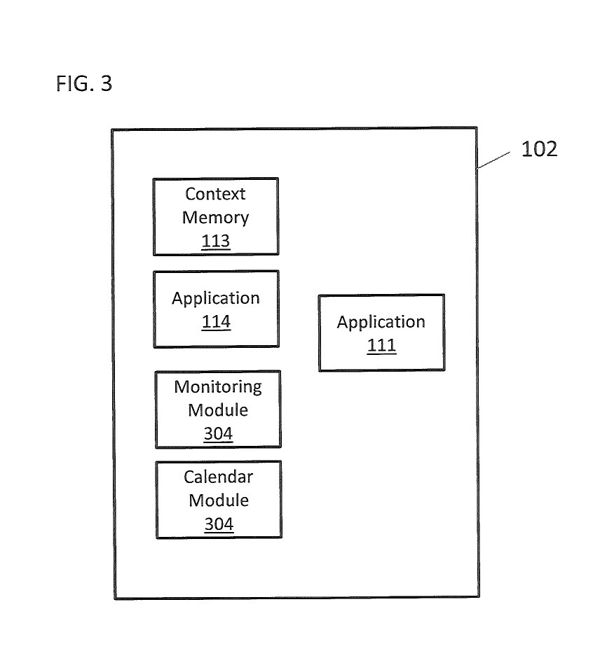

In the above example, the context memory 113 was described as pertaining to route history related to a GPS device. The context memory 113 could also work in combination with other modules that monitor interactions with other applications 114. For example, and as shown in FIG. 3, the mobile device 102 could include the context memory 113 that retains a history of user's past historical usage for a particular application on the mobile device 102. The mobile device 102 could also include a monitoring module 300 that monitors the user's current activity on the mobile device 102 and a location module 302 that provides the user's location. Further, the mobile device 102 could include calendar module 304 that provides the user's calendar scheduling on mobile device. As described above, the application 111 could utilize any of the information from any of the modules to determine is a battery saving action should be taken. The actions could be any those described above.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A mobile device comprising:
a cellular network connection device capable of connecting to a cellular network;
an application that communicates through the cellular network connection device to a remote device;
a context memory that records information about a user's use of the mobile device; and
a battery management module that limits a frequency that the application communicates to the remote device based on a current location of the mobile device and information in the context memory.

2. The mobile device of claim 1, wherein the context memory includes information related a driving route previously taken by the user.

3. The mobile device of claim 2, wherein the battery management module reduces the frequency when the mobile device is near a destination it has previously reached.

4. The mobile device of claim 2, wherein the battery management module performs a secondary battery management battery usage reduction when the mobile device is in a certain location.

5. The mobile device of claim 4, wherein the secondary battery management battery usage reduction includes one of: closing the application and dimming a screen of the mobile device.

6. The mobile device of claim 1, wherein the application is a driving guidance program and the battery management module causes the application to close when the mobile phone reaches a destination of a route provided by the driving guidance program.

7. The mobile device of claim 1, wherein the application is a crowd sourcing application that communicates with other mobile device near the mobile device and the frequency is limited by closing the application.

8. A mobile device comprising:
a cellular network connection device capable of connecting to a cellular network;
an application that operates on the mobile device and communicates with one or more other mobile devices;
a context memory that records information about a user's use of the mobile device; and
a battery management module that limits at least one battery consuming aspect of the application based on a current location of the mobile device or of the one or more other mobile devices.

9. The mobile device of claim 7, wherein the context memory includes related to locations where all applications are closed.

10. The mobile device of claim 8, wherein the current location is a church, movie theater or a hospital.

11. The mobile device of claim 9, wherein the at least one battery consuming aspect includes at least one of: closing the application; limiting a frequency of communication between the mobile device and another mobile device; dimming the screen and muting all sounds related to the application.

12. The mobile device of claim 7, wherein the battery management module reduces a frequency the application communicates an external server when the mobile device is near a destination it has previously reached.

13. A method of controlling battery usage in a mobile device comprising:
determining a frequency an application operating on the mobile communicates through a cellular network connection device to a remote device;
recording information in a context memory on the mobile phone that records information about a user's use of the mobile device; and
limiting a frequency with a battery management module on the mobile device that the application communicates to the remote device based on a current location of the mobile device and information in the context memory.

14. The method of claim 13, wherein the context memory includes information related a driving route previously taken by the user.

15. The method of claim 14, wherein the battery management module reduces the frequency when the mobile device is near a destination it has previously reached.

16. The method of claim 14, wherein the battery management module performs a secondary battery management battery usage reduction when the mobile device is in a certain location.

17. The method of claim 16, wherein the secondary battery management battery usage reduction includes one of: closing the application and dimming a screen of the mobile device.

18. The method of claim 13, wherein the application is a driving guidance program and the battery management module causes the application to close when the mobile phone reaches a destination of a route provided by the driving guidance program.

19. The method of claim 13, wherein the application is a crowd sourcing application that communicates with other mobile device near the mobile device and the frequency is limited by closing the application.
